(19) United States
(12) Patent Application Publication
(10) Pub. No.: US 2006/0291429 A1
(43) Pub. Date: Dec. 28, 2006

(54) Dynamic UMTS transport block size adjustment

(75) Inventor: Pawel O. Matusz, Rumia (PL)

Correspondence Address: LeMOINE PATENT SERVICES, PLLC, C/O INTELLEVATE, P. O. BOX 52050, MINNEAPOLIS, MN, 55402, US

(73) Assignee: Intel Corporation

(21) Appl. No.: 11/166,613

(22) Filed: Jun. 24, 2005

(51) Int. Cl. H04B 7/216

(52) U.S. Cl. 370/335; 370/395.5; 370/342

(57) ABSTRACT

A transport format combination set (TFCS) in a universal mobile telecommunication system (UMTS) includes transport format combinations (TFCs) that specify transport formats (TFs) having various transport block (TB) sizes for a single channel.

### FIELD

The present invention relates generally to 3G communications systems, and more specifically to transport formats in Universal Mobile Telecommunications Systems (UMTS).

### BACKGROUND

In UMTS, frames exchanged over the radio interface include transport blocks (TBs). A transport format (TF) specifies the number and size of TBs to be transmitted in a frame, and transport format combinations (TFCs) are combinations of TFs specifying the number and size of TBs to be transmitted in a frame for each of multiple channels. A device communicating in a UMTS environment selects a TFC from a set of available TFCs. This set is referred to as the transport format combination set (TFCS).

### BRIEF DESCRIPTION OF THE DRAWINGS

FIG. 1 shows user equipment (UE) communicating with a radio network controller (RNC) in a universal mobile telecommunication system (UMTS);

FIG. 2 shows radio frames with different transport block (TB) sizes;

FIGS. 3-6 show data structures with transport format combination sets (TFCS) in accordance with various embodiments of the present invention;

FIG. 7 shows a flowchart in accordance with various embodiments of the present invention; and

FIG. 8 shows a diagram of an electronic system in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

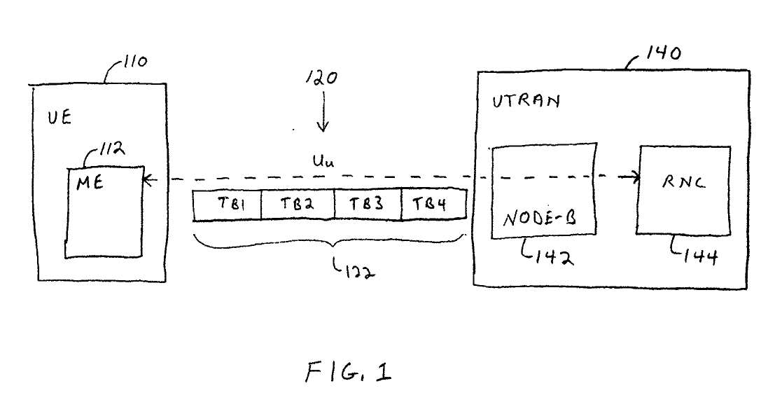

FIG. 1 shows user equipment (UE) communicating with a radio network controller (RNC) in a universal mobile telecommunication system (UMTS). Shown in FIG. 1 are user equipment 110 and radio network controller (RNC) 144 communicating over a radio interface 120. Communication takes place using radio frames, one of which is shown at 122. UE 110 includes mobile equipment (ME) 112. ME 112 may be any type of mobile equipment, such as a mobile phone, personal digital assistant (PDA), laptop computer, or the like.

RNC 144 and Node-b 142 are included within UMTS terrestrial radio access network (UTRAN) 140. Node-b 142 is a base station that provides physical access to the radio interface 120 for RNC 144. RNC 144 provides a medium access control (MAC) layer that communicates with a MAC layer in ME 112.

Embodiments of the various blocks shown in FIG. 1 are described in various UMTS specifications. For example, some blocks are described in the 3^{rd} Generation Partnership Project Technical Specification Group Radio Access Network MAC protocol specification (release 1999) TS 25.321. Also for example, some blocks are described in the 3^{rd} Generation Partnership Project Technical Specification Group Radio Access Network Radio Resource Control (RRC) protocol specification (release 1999) TS 25.331. Many other UMTS technical specifications exist that may describe the blocks shown in FIG. 1 and other blocks applicable to UMTS.

In UMTS, frames exchanged over the radio interface (Uu) are processed by the radio interface protocol stack, which exists in ME 112 and in RNC 144. The radio interface protocol stack processes data from upper layers and creates transport blocks (TBs) of a certain length, ready to send as data over the radio interface after some more operations performed in the physical layer (e.g. scrambling, interleaving, data rate matching, modulation and coding). During each radio frame, a number of transport blocks (TBs) can be transmitted between ME 112 and RNC 144.

According to the amount of data to send to/from a certain ME, the medium access control (MAC) scheduler, responsible for scheduling TBs to send over the radio interface, chooses one of the available transport format combinations. These combinations specify several variations of the number of transport blocks that can be sent in one radio frame on all ME channels; they are chosen by the radio resource control (RRC) layer in such a way that the traffic on all ME channels does not exceed bandwidth allocated for this ME.

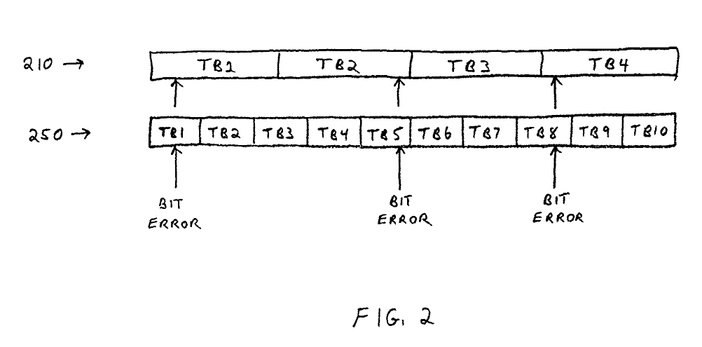

In UMTS, variances in signal quality (and hence transmission quality) may be counteracted by a power control mechanism. Additionally, an automatic repeat request (ARQ) in the radio link control (RLC) layer operating in acknowledged mode (AM) enables retransmission of erroneous TBs (for which the attached CRC—cyclic redundancy checksum—indicates that there were bit errors on the radio interface). In case of a higher bit error rate (BER), the block error rate (BLER) is also higher. Power control may not always be able to compensate for lower signal quality (as measured by a lower S/N signal-to-noise ratio) by increasing transmission power. So if BLER increases, more TBs contain errors and have to be retransmitted. For a certain value of BER, the longer is a TB the greater is the possibility that it will contain an error. This is described more fully below with reference to FIG. 2. Additionally, the longer is the erroneous TB, the more data has to be retransmitted because only whole TBs can be retransmitted.

Various embodiments of the present invention provide radio link control (RLC) and medium access control (MAC) implementations that allow the TB size to be changed dynamically from one radio frame to the next. Dynamic modification of TB size allows the use of longer TBs if signal quality is high (and there are few errors on the radio interface) and shorter TBs if the signal quality is lower (and there are more errors on the radio interface). This mechanism enables UMTS to operate more efficiently, be more robust and decreases the amount of data that has to be retransmitted.

FIG. 2 shows radio frames with different transport block (TB) sizes. Radio frame 210 includes four transport blocks, shown as TB1 through TB4. Radio frame 250 includes ten transport blocks shown as TB1 through TB10. Each of radio frames 210 and 250 include the same amount of data: radio frame 210 includes fewer TBs of larger size, and radio frame 250 includes more TBs of smaller size.

Three bit errors are shown in FIG. 2, and each bit error occurs at the same point in each of radio frames 210 and 250. Accordingly, each of radio frames 210 and 250 are subject to the same bit error rate (BER); however, the block error rate (BLER) is lower for radio frame 250 with shorter transport blocks (TBs). This means that although the same rate of bit errors occurs in the data stream, less data has to be retransmitted in case of shorter blocks (radio frame 250), because the ARQ mechanism in RLC AM in UMTS retransmits whole TBs. In the example of FIG. 2, radio frame 210 has a BLER of ¾ and radio frame 250 has a BLER of 3/10 for the same BER. Accordingly, ¾ of the transport blocks (TBs) in radio frame 210 would have to be retransmitted, whereas only 3/10 of the transport blocks (TBs) in radio frame 250 would have to be retransmitted.

Power control procedures try to keep transmission quality at certain levels (which may be imposed by channel QoS requirements), but sometimes it is hard because transmitted signal strength cannot be too high (to avoid causing too much signal interference). Various embodiments of the present invention may be used to improve transmission quality by decreasing BLER, either if power control cannot correctly adjust power or to decrease the amount of retransmitted data. Decreasing TB length may have a small negative impact on UTMS performance because more bandwidth is used for TB headers, but this may be traded off with the bandwidth savings due to fewer TB retransmissions.

UMTS radio access bearers (RABs), i.e. channels, can operate in three modes: transparent mode (TM), unacknowledged mode (UM) and acknowledged mode (AM). In TM, which is used mainly for voice traffic, TB length can be different on a single channel, but TM is the simplest mode and does not offer reordering and sequence checking. UM enables TB (or, precisely, RLC PDU) sequence ordering and detection of missing RLC PDUs, but retransmissions have to be done by higher layers. Only AM provides an automatic repeat request (ARQ) mechanism to retransmit erroneous or lost TBs at the UMTS RLC level.

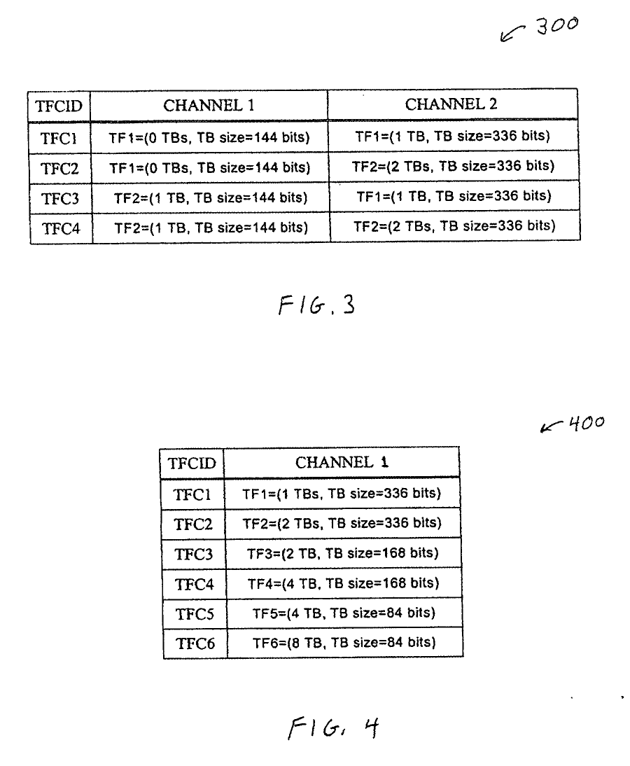

For each radio frame, the MAC scheduler chooses, for a certain ME, one of the available transport format combinations (TFC) from a transport format combination set (TFCS). Each TFC contains transport formats (TF) for each channel configured for this ME. Each TF describes, among other things, the number and length of TBs that can be sent. An example of a TFCS for an ME with 2 channels is shown in FIG. 3.

In the example TFCS of FIG. 3, either 0 or 1 TB containing 144 bits can be sent on channel #1, and 1 or 2 TBs containing 336 bits can be sent on channel #2. Note that in TFCS 300, all TF elements for one channel contain TBs of the same size (144 bits for channel #1 and 336 bits for channel #2). When a TFCS is structured in this manner, the MAC scheduler cannot dynamically modify the TB size from one radio frame to the next, because even if the MAC scheduler chooses a different transport frame combination (TFC), TB sizes remain constant on each channel.

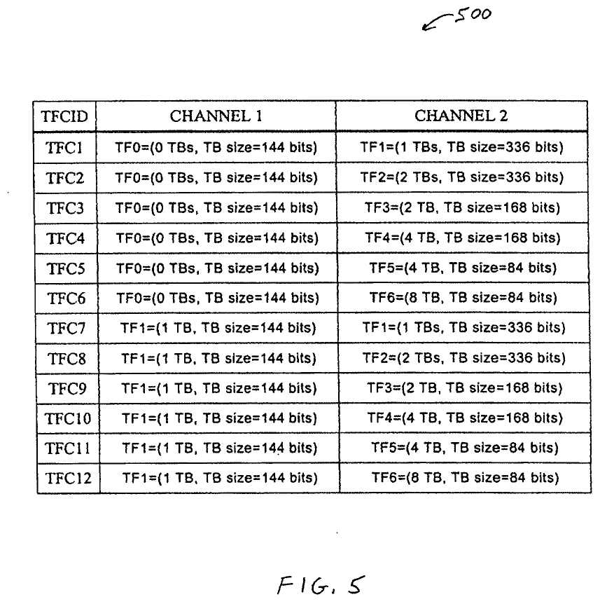

Various embodiments of the present invention provide transport format combinations (TFCs) with varying TB sizes for one or more channels in a single TFCS. To dynamically change the TB size, the MAC scheduler need only select a different TFC from within the TFCS. Example transport format combination sets (TFCSs) having varying TB sizes are shown in FIGS. 4-6.

FIG. 4 shows an example TFCS having varying TB sizes for one channel. Note that each of the TFCs within TFCS 400 have the same defined throughput. That is, the total number of transmitted bits is the same for each TFC. The defined throughput of TFCS 400 is the same as the defined throughput of channel 2 of TFCS 300 (FIG. 3).

In various embodiments of the present invention, a MAC scheduler in a ME or RNC may choose a TFC according to current BER (in order to maintain a similar BLER all the time). For example, if signal quality decreases, the scheduler may choose to send 2 TBs, each containing 168 bits (TFC3 in FIG. 4) instead of 1 TB containing 336 bits (TFC1 in FIG. 4). If signal quality still decreases, the scheduler may choose to send 4 TBs, each containing 84 bits. This way, if a bit error occurs and a TB has to be retransmitted, less data (a shorter TB) has to be retransmitted. When the signal quality increases again, the scheduler may begin choosing TFCs with longer TBs again to avoid using bandwidth for TB headers.

In some embodiments, TB size is modified in response to BER, and in other embodiments, TB size is modified in response to BLER. Further, in some embodiments, TB size is modified in response to a combination of one or both of BER and BLER along with information regarding current transmit power levels. For example, errors may be managed by modifying power levels until the power level reaches a certain point at which errors are managed by dynamically adjusting TB size. There are other methods to improve transmission quality in case of changing radio conditions, and these other methods may be combined with dynamic TB size adjustment without departing from the scope of the present invention.

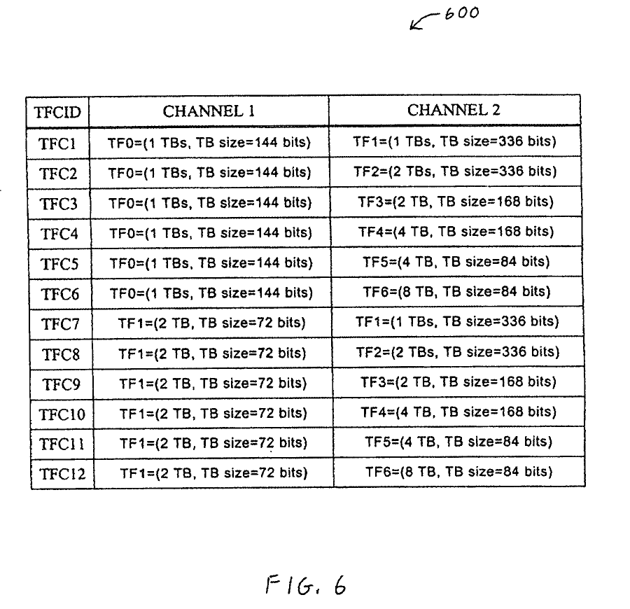

FIGS. 5 and 6 show data structures with transport format combination sets (TFCSs) in accordance with various embodiments of the present invention. TFCS 500 (FIG. 5) includes 12 transport format combinations (TFCs) labeled TFC1 through TFC12. Each TFC specifies a transport format (TF) for two channels shown as channel #1 and channel #2. In embodiments represented by FIG. 5, the TFCS includes different TB sizes for less than all channels. For example, channel #2 has different TB sizes, but channel #1 has a single TB size of 144 bits. Embodiments represented by FIG. 6, however, include different TB sizes for all channels. For example, channel #1 and channel #2 have different TB sizes. A TFCS may include any number of TFCs that specify different TB sizes for any number of channels without departing from the scope of the present invention.

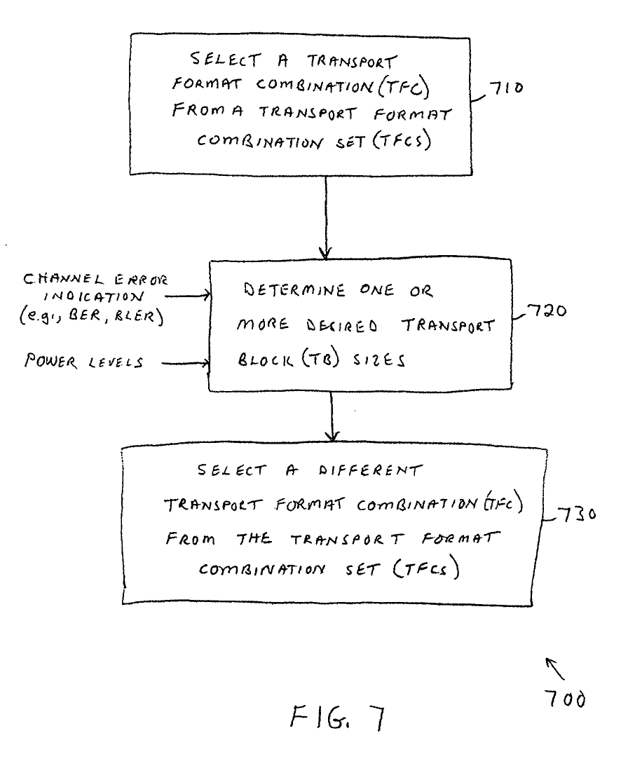

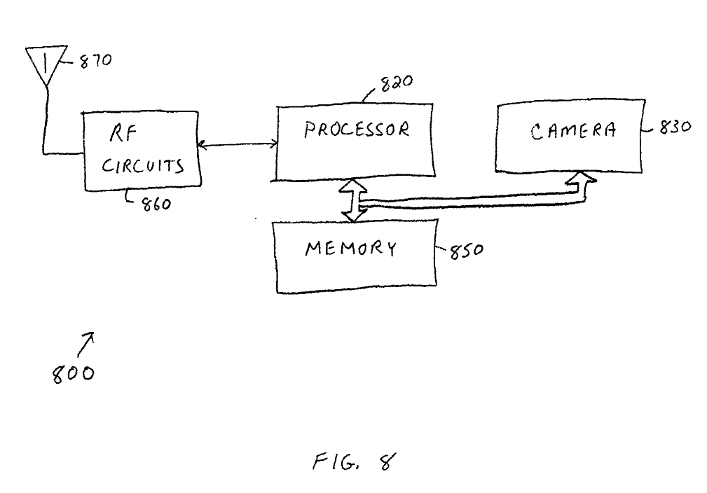

FIG. 7 shows a flowchart in accordance with various embodiments of the present invention. In some embodiments, method 700, or portions thereof, is performed by user equipment (UE) or mobile equipment (ME), embodiments of which are shown in previous figures. In other embodiments, method 700 is performed by a medium access control (MAC) layer or radio link control (RLC) layer in an electronic system. Method 700 is not limited by the particular type of apparatus performing the method. The various actions in method 700 may be performed in the order presented, or may be performed in a different order. Further, in some embodiments, some actions listed in FIG. 7 are omitted from method 700.

Method 700 is shown beginning with block 710 in which a transport format combination (TFC) is selected form a transport format combination set (TFCS). By selecting a TFC, one or more transport block (TB) sizes may be set. For example, a TFC may be selected from TFCS 500 (FIG. 5) or TFCS 600 (FIG. 6), and TB sizes may be set for channels 1 and 2 according to the TFC selected.

One or more radio frames may be transmitted in one or more channels using parameters specified by the transport formats (TFs) according to the TFC selected at 710. For example, referring now back to FIG. 2, one or more radio frames such as radio frames 210 and 250 may be transmitted using the TB sizes and number of TBs specified in the selected TFC.

At 720, one or more desired TB sizes may be determined in response to various criteria. For example, a channel error indication (e.g., BER or BLER) may be received and a desired TB size may be determined in response thereto. If channel errors have increased, or if it is determined that channel errors are too high, the actions of 720 may determine that a smaller TB size should be used. Further, the actions of 720 may determine TB sizes in response to power levels. For example, a TB size may be held constant while the power level is low enough to allow for an increase in transmit power to compensate for increased channel errors. In some embodiments, it may be desirable to not increase a transmit power level, and TB sizes may be decreased in response to increased channel errors.

At 730, a different TFC is selected from the TFCS. The different TFC selected may correspond to a TFC having TB sizes determined by the actions of 720. For example, if TB sizes are to be reduced, the TFC having TB sizes reduced for one or more channels may be selected.

Utilizing method 700, TB sizes may be dynamically adjusted from one radio frame to the next radio frame. For example, the actions of 710 may be performed for a first radio frame, and the actions of 730 may be performed for a subsequent radio frame, and the actions of 720 may performed in the interim period.

FIG. 8 shows a system diagram in accordance with various embodiments of the present invention. FIG. 8 shows system 800 including processor 820, memory 850, radio frequency (RF) circuit 860, antenna 870, and camera 830. In operation, system 800 sends and receives signals using antenna 870, and these signals are processed by the various elements shown in FIG. 8. Antenna 870 may be a directional antenna or an omni-directional antenna. As used herein, the term omni-directional antenna refers to any antenna having a substantially uniform pattern in at least one plane. For example, in some embodiments, antenna 870 may be an omni-directional antenna such as a dipole antenna, or a quarter wave antenna. Also for example, in some embodiments, antenna 870 may be a directional antenna such as a parabolic dish antenna, a patch antenna, or a Yagi antenna. In some embodiments, antenna 870 may include multiple physical antennas.

Radio frequency circuit 860 communicates with antenna 870 and processor 820. In some embodiments, RF circuit 860 includes a physical interface (PHY) corresponding to a communications protocol. For example, RF circuit 860 may include modulators, demodulators, mixers, frequency synthesizers, low noise amplifiers, power amplifiers, and the like. In some embodiments, RF circuit 860 may include a heterodyne receiver, and in other embodiments, RF circuit 860 may include a direct conversion receiver. In some embodiments, RF circuit 860 may include multiple receivers. For example, in embodiments with multiple antennas 870, each antenna may be coupled to a corresponding receiver. In operation, RF circuit 860 receives communications signals from antenna 870, and provides analog or digital signals to processor 820. Further, processor 820 may provide signals to RF circuit 860, which operates on the signals and then transmits them to antenna 870.

Memory 850 represents an article that includes a machine readable medium. For example, memory 850 represents a random access memory (RAM), dynamic random access memory (DRAM), static random access memory (SRAM), read only memory (ROM), flash memory, magnetic disk, CD-ROM, or any other type of article that includes a medium readable by processor 820. Memory 850 may store instructions for performing various method embodiments of the present invention. For example, memory 850 may include instructions that when accessed by processor 820 cause processor 820 to perform methods represented by FIG. 7 or methods described with reference to other figures. Further, memory 850 may store data structures that hold transport format combination sets (TFCSs). For example, any of the data structure embodiments described herein may be stored in memory 850 for use by electronic system 800.

Example systems represented by FIG. 8 include cellular phones, personal digital assistants, handheld communications devices, or any other suitable system. For example, electronic system 800 may be user equipment (UE) or mobile equipment (ME) in a UMTS system. Many other systems uses for the various embodiments of the present invention exist. For example, embodiments of the present invention may used in any type of system without a camera.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
selecting a transport format combination (TFC) from a plurality of transport format combinations (TFCs) in a transport format combination set (TFCS), wherein at least two of the plurality of transport format combinations (TFCs) specify different transport block (TB) sizes for a channel.

2. The method of claim 1 wherein selecting is performed in response to a block error rate (BLER).

3. The method of claim 2 wherein selecting a transport format combination (TFC) comprises selecting a transport format combination (TFC) that adjusts the transport block (TB) size in the channel when the block error rate (BLER) changes.

4. The method of claim 1 wherein selecting is performed in response to a bit error rate (BER).

5. The method of claim 4 wherein selecting a transport format combination (TFC) comprises selecting a transport format combination (TFC) that adjusts the transport block (TB) size in the channel when the bit error rate (BER) changes.

6. The method of claim 1 wherein selecting a transport format combination (TFC) is performed in response to errors in the channel.

7. The method of claim 6 wherein selecting a transport format combination (TFC) is further performed in response to a transmit power level.

8. A method comprising:
setting a transport block (TB) size by selecting a transport format combination (TFC) from a transport format combination set (TFCS);
receiving an indication of errors; and
modifying the transport block (TB) size by selecting a different transport format combination (TFC) from the transport format combination set (TFCS).

9. The method of claim 8 wherein receiving an indication of errors comprises receiving a bit error rate (BER).

10. The method of claim 9 wherein modifying the transport block (TB) size comprises reducing the transport block (TB) size in response to the bit error rate (BER).

11. The method of claim 8 wherein:
setting a transport block (TB) size comprises selecting a transport format combination (TFC) for use in a first radio frame; and
wherein modifying the transport block (TB) size comprises selecting a different transport format combination (TFC) for use in a subsequent radio frame.

12. The method of claim 8 wherein the method is performed in a medium access control (MAC) layer of a user equipment (UE).

13. An apparatus including a machine accessible media having a data structure stored thereon, the data structure comprising:
a plurality of transport formats (TFs) for a channel, wherein each of the plurality of transport formats (TFs) specifies a transport block (TB) size and a number of transport blocks (TBs) to be transmitted in a frame, and wherein at least two of the plurality of transport formats (TFs) specify different transport block (TB) sizes.

14. The apparatus of claim 13 wherein each of the plurality of transport formats (TFs) is paired with at least one other transport format (TF) to form a plurality of transport format combinations (TFCs).

15. The apparatus of claim 14 wherein the plurality of transport format combinations (TFCs) specify a plurality of transport block (TB) sizes for each of at least two channels.

16. The apparatus of claim 13 wherein the media is accessible by a user equipment (UE) in a universal mobile telecommunication system (UMTS).

17. The apparatus of claim 13 wherein the media is accessible by a radio network controller (RNC) in a universal mobile telecommunication system (UMTS).

18. An electronic system comprising:
a camera;
a processor coupled to the camera; and
a memory accessible by the processor, the memory having instructions stored thereon that when accessed cause the processor to select a transport format combination (TFC) from a plurality of transport format combinations (TFCs) in a transport format combination set (TFCS), wherein at least two of the plurality of transport format combinations (TFCs) specify different transport block (TB) sizes for a channel.

19. The electronic system of claim 18 wherein selecting is performed in response to a bit error rate (BER).

20. The electronic system of claim 19 wherein selecting a transport format combination (TFC) comprises selecting a transport format combination (TFC) that adjusts the transport block (TB) size in the channel when the bit error rate (BER) changes.
